(19) United States
(12) Patent Application Publication
(10) Pub. No.: US 2007/0258505 A1
(43) Pub. Date: Nov. 8, 2007

(54) APPARATUS FOR THERMOCOUPLE SETTING AND FLAT ZONE PROCEDURE IN A FURNACE

(75) Inventors: Sanjeev Jindal, Singapore (SG); Gerardo Abaring Pelaez JR., Singapore (SG); Al Johan Mohamed, Singapore (SG)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: Systems on Silicon Manufacturing Co. Pte. Ltd., Singapore (SG)

(21) Appl. No.: 11/381,911

(22) Filed: May 5, 2006

(51) Int. Cl. G01K 7/00

(52) U.S. Cl. 374/179

(57) ABSTRACT

A thermocouple jig for positioning a thermocouple in a wafer fabricating furnace is described. The jig has a bar having predetermined marking corresponding to flat zones in the process tube of the furnace, a rail parallel to the bar, a rod extending substantially perpendicular from the rail adapted to receive and hold a thermocouple, the rod slidable along the rail, and a motor to drive the rod along the rail. The thermocouple mounted onto the rod is moveable along a vertical axis of the furnace to a desired flat zone by driving the rod along the rail to a predetermined mark which corresponds to the flat zone on the bar.

### TECHNICAL FIELD

The invention broadly relates to apparatus for use in furnaces for the manufacture of products such as semiconductor devices. More particularly, the invention relates to apparatus for setting of thermocouples and flat zone marking in such furnaces.

### DESCRIPTION OF THE PRIOR ART

Furnaces used in the semiconductor industry are operated to generate a nearly flat profile. Referring to FIG. 1 the process tubes 101 used in the furnaces 100 are the circular type and vary in diameter according to the application. Generally the temperature along any given diameter of the tube is the same as that at any other point along the same diameter. The temperature control for this type of furnace is designed to regulate the temperature along the axis of the tube. A flat profile for the process tube 101, therefore, means that the temperature at one point along the axis of the tube is the same as the temperature at all other points along the axis for points. The points with the same tempreture are called the flat zone 102 of the process tube 101.

The temperature of the process tube 101 is maintained by regulating the power of each of the heating zones 110-114 within the process tube 101. The temperature is measured at one point (usually in the centre) of each heating zone by a thermocouple, and the feedback from this thermocouple regulates the power to the zone. The thermocouples used to measure temperature within the process tube 101 often include an elongated housing placed between the wall of the process tube 101 and the quartz liner of the furnace with very close tolerance. If the thermocouple is misaligned, contact between the thermocouple and the quartz liner may cause formation of quartz particles that can contaminate the wafers. Further, such misalignment can result in incorrect temperature profiles because the temperature is being measured further from the heating elements than called for by the furnace design criteria. The control thermocouples reside outside of the process tube 101 whose axis is coincident with that of the furnace.

The flat profile of the process tube 101 is maintained by regulating the power to each heating zone within the process tube 101. The temperature is measured at one point (usually in the centre) of each heating zone by a thermocouple, and the feedback from this thermocouple regulates the power to the zone.

Routine replacement of thermocouples is required over the life of a furnace. However, conventional replacement of thermocouple and flat zone marking for a furnace is a time-consuming process and is prone to errors. Each time a thermocouple is replaced new flat zone markings are required. Referring to FIG. 4, such markings are made using a ruler 210 having standard measurement units. Errors in thermocouple setting or marking of flat zone leads to extended downtime of the furnace. Further, once sited, thermocouples are not accessible from the exterior of the furnace to facilitate correction of errors compounding the downtime of the furnace. In order to rectify the errors the process tube of the furnace is removed, the thermocouples are re-positioned and thereafter the process tube is mounted again.

### SUMMARY OF THE INVENTION

It is an object of the present invention to provide an apparatus and method for marking the thermocouple setting and flat zones that overcomes the above disadvantages or at least provides the public or industry with a useful choice.

Accordingly in as first embodiment the invention can be said to consist in a thermocouple jig for positioning a thermocouple in a wafer fabricating furnace comprising:
a bar having predetermined marking corresponding to flat zones in the process tube of said furnace,
a rail parallel to said bar;
a rod extending substantially perpendicular from said rail adapted to receive and hold a thermocouple, said rod slidable along said rail; and
a motor to drive said rod along said rail;
wherein the thermocouple mounted onto the rod is moveable along a vertical axis of the furnace to a desired flat zone by driving the rod along said rail to a predetermined mark which corresponds to the flat zone on said bar.

Preferably said predetermined marking are colour coded.

Preferably said bar having predetermined markings for a plurality of different furnaces.

It is a further object to reduce the number of errors during thermocouple setting and flat zone marking in a furnace for the manufacture of semiconductor devices this is achieved by a thermocouple jig according to the design.

### BRIEF DESCRIPTION OF THE DRAWINGS

Exemplary embodiments of the present invention will be described below with reference to the accompanying drawings. It will be understood that the depicted elements may be simplified and/or merely exemplary.

FIG. 1 is a schematic of a furnace showing the flat zones,

FIG. 2 is a drawing of the thermocouple jig of the present invention,

FIG. 3 is drawing of the thermocouple jig of FIG. 2, with a thermocouple attached,

FIG. 4 is a drawing of a prior art measuring device, and

FIG. 5 is a drawing of the measuring device of the present invention for locating thermocouple zone.

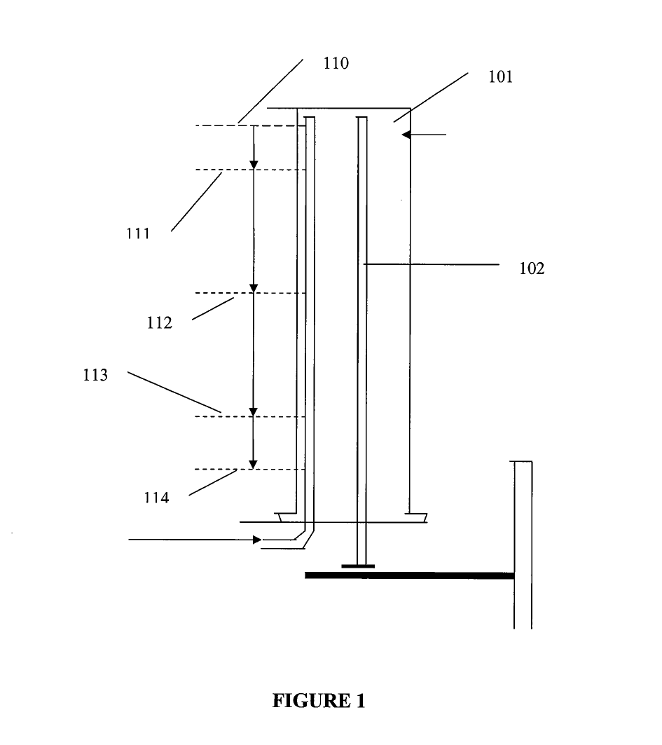

### DETAILED DESCRIPTION OF THE INVENTION

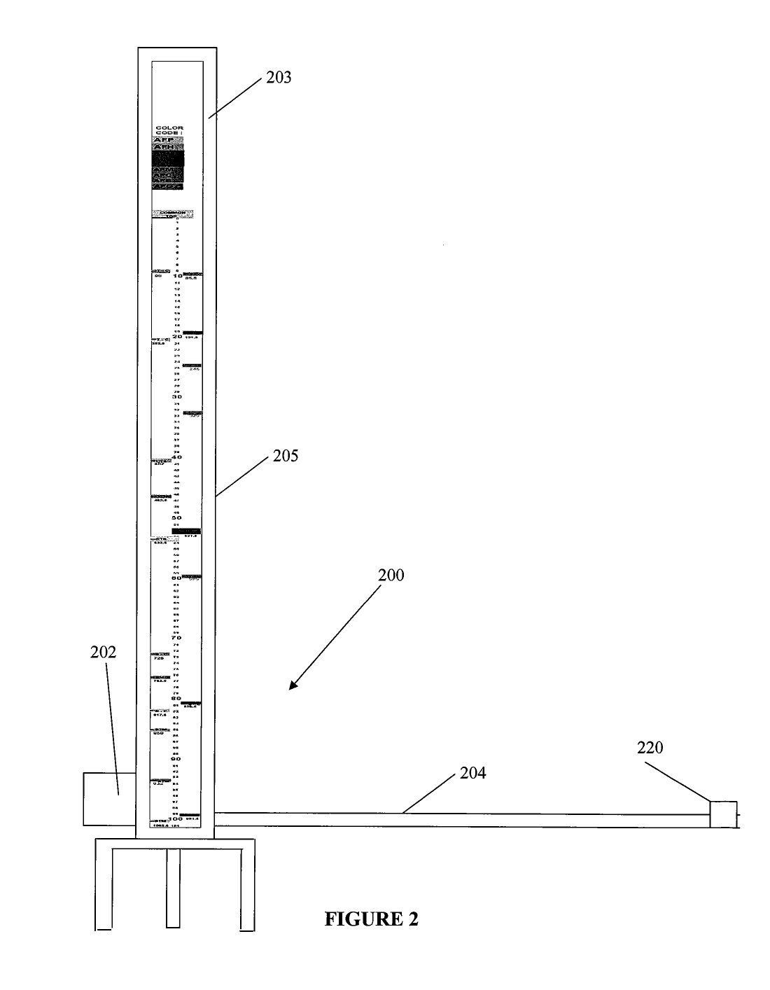

Referring to FIG. 2 according to an embodiment of the invention the thermocouple jig 200 comprise of a motor 202, a rail 203 mounted on or part of a bar 205 and a rod 204 extending from the rail 203. The motor 202 drives or slides the rod 204 of the thermocouple jig along the rail 203. The thermocouple is able to move along the axis of a process tube 101 guided by the rail 203 and rod 204. In use the thermocouple jig is positioned external to the process tube 101 of the furnace 100 and parallel to the process tube 101.

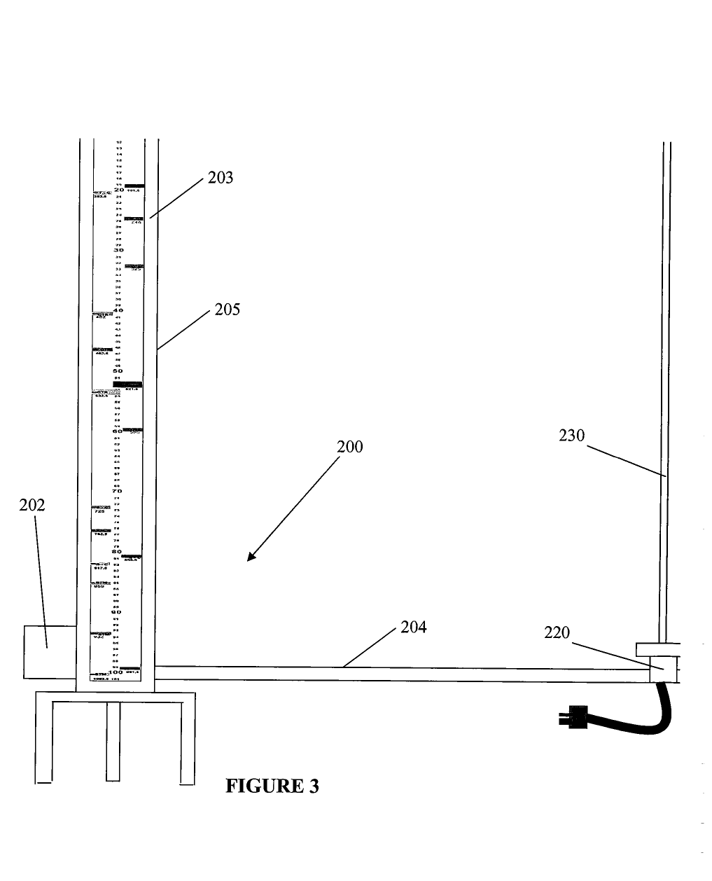

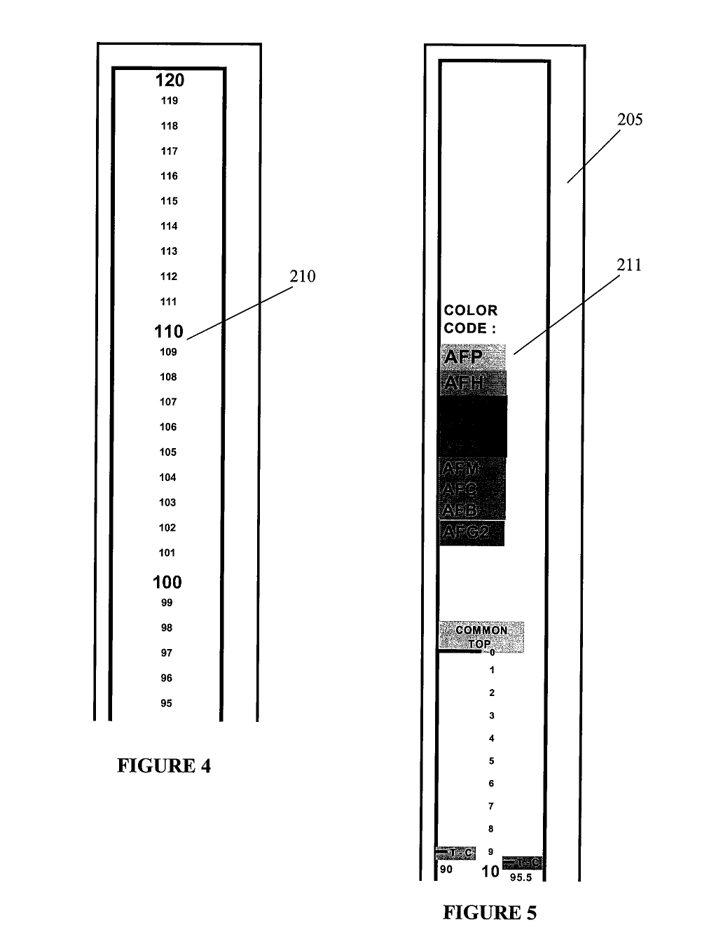

The rod 204 is able to slide up and down on the rail 203. Referring to FIG. 3 the thermocouple 230 also moves up and down with the sliding rod 204. The end of the rod 204 has a holder 220, which holds the thermocouple 230 in position.

Referring to FIG. 5 the bar 205 can be made from any suitable material. Generally the bar 205 is made of a metallic material. Marks 211 are positioned on the bar 205. The markings 211 are measured based on the manufacturer of the furnace/process tubes drawings.

Different furnaces have different start and end position of zones. If there are for example five zones, numbered 1, 2, 3, 4 and 5 then marking are created for each zone. The markings are created using the manufacturer's drawings. Among other information the manufacturer's drawings have measurements for the location of the thermocouple locations and the number of thermocouples to use with a given furnace/process tube. The zone positions are measured and marked on a common scale for all the furnaces. The common position is the top position on the common scale. The use of a common top gives the relative positions of different zone marking with respect to a common top.

The markings 211 correspond to temperature flat zones of the process tube 101. The markings 211 may be printed or engraved directly onto the bar. Alternatively, the markings may be printed or engraved onto an attachment, which can be fastened to the bar by suitable means. Such means include adhesives, riveting, screw, nuts & bolts and magnetic holders. Because the furnaces are not in use while the thermocouples are replaced there is no need for the marking attachment to be heat resistant. The attachment may be made from material similar to that of the bar. Alternatively, the attachment may be made from plastics or any suitable material.

Different colour marking are used for different furnaces/process tubes so that one marking attachments may be used for multiple furnaces. Alternatively if the marking attachment is readily detachable then a single furnace may be marked on a single marking attachment. To position a thermocouple 230, a thermocouple 230 is mounted onto the rod of the thermocouple jig, and the motor 202 is activated. The motor 202 drives the rod 204 along the rail 203. The movement of the rod 204 along the rail 203 results in a corresponding movement of the thermocouple 230 along the vertical axis of the process tube 101. The rod 204 is then moved to a mark on the bar 205, which corresponds to a flat zone of the process tube 101. By selecting a predetermined mark the thermocouple 230 is positioned at the corresponding flat zone. Thus a thermocouple 230 can be positioned at a temperature flat zone by moving the rod 204 to a mark 210 on the bar 205.

The foregoing description of the preferred embodiment of the invention has been presented for purposes of illustration and description. It is not intended to be exhaustive or to limit the invention to the precise forms disclosed, since many modifications or variations thereof are possible in the light of the above teaching. All such modifications and variations are within the scope of the invention. The embodiments described herein were chosen and described in order best to explain the principles of the invention and its practical application, thereby to enable others skilled in the art to utilise the invention in various embodiments and with various modifications as are suited to the particular use contemplated thereof. It is intended that the scope of the invention be defined by the claims appended hereto, when interpreted in accordance with the full breadth to which they are legally and equitably suited.

1. A thermocouple jig for positioning a thermocouple in a wafer fabricating furnace comprising:
a bar having predetermined marking corresponding to flat zones in the process tube of said furnace,
a rail parallel to said bar;
a rod extending substantially perpendicular from said rail adapted to receive and hold a thermocouple, said rod slidable along said rail; and
a motor to drive said rod along said rail;
wherein the thermocouple mounted onto the rod is moveable along a vertical axis of the furnace to a desired flat zone by driving the rod along said rail to a predetermined mark which corresponds to the flat zone on said bar.

2. A thermocouple jig for positioning a thermocouple in a wafer-fabricating furnace as claimed in claim 1 wherein said predetermined marking are colour coded.

3. A thermocouple jig for positioning a thermocouple in a wafer-fabricating furnace as claimed in claim 1 or claim 2 having predetermined markings for a plurality of different furnaces.
